(19) United States
(12) Patent Application Publication
(10) Pub. No.: US 2006/0091726 A1
(43) Pub. Date: May 4, 2006

(54) Brake system

(75) Inventors: Kunimichi Hatano, Saitama (JP); Hiromi Inagaki, Saitama (JP); Osamu Yamamoto, Saitama (JP); Takehiro Horiuchi, Saitama (JP); Kiyotaka Minoura, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/252,186

(22) Filed: Oct. 17, 2005

(30) Foreign Application Priority Data
Oct. 18, 2004 (JP) 2004-302498

(51) Int. Cl. B60T 13/74; B60T 13/18; B60T 8/88

(52) U.S. Cl. 303/122.13; 303/3; 303/11

(57) ABSTRACT

During normal operation in which an electric braking device is operative, when a depressing force cut-off valve is closed and communication between a master cylinder and a disk brake system of a front wheel is cut off, the front wheel is braked by a brake pad directly driven by drive force of the electric braking device. When there is an abnormality in which the electric braking device breaks down, a wheel cylinder of a drum brake system of a rear wheel is operated by brake fluid pressure generated by the master cylinder operated by a driver's braking operation. Thus, since the drum brake system having a high braking function is operated in case of abnormality, the braking force is higher than the braking force during normal operation, thereby reliably stopping the vehicle.

### CROSS-REFERENCE TO RELATED APPLICATIONS

The present invention claims priority under 35 USC 119 based on Japanese patent application No. 2004-302498, filed on Oct. 18, 2004. The subject matter of this priority document is incorporated in its entirety by reference herein.

### BACKGROUND OF THE INVENTION

1. Field of the Invention

The present invention relates to a brake system in which during normal operation a wheel is braked by electric braking device. When there is an abnormality in which the electric braking device becomes inoperative, a wheel is braked using brake fluid pressure generated by a master cylinder actuated by a driver's braking operation.

2. Description of the Related Art

A so-called brake-by-wire type brake system is known from Japanese Patent Publication No. 3205570 in which, during normal operation, an electrically operated fluid pressure outputting device for generating brake fluid pressure is operative. A disk brake system for braking a wheel is actuated by brake fluid pressure generated by the electrically operated fluid pressure outputting device when communication between the disk brake system and a master cylinder that generates brake fluid pressure by a driver depressing a brake pedal is cut off by means of a fail-safe solenoid switch valve. When there is an abnormality in which the electrically operated fluid pressure outputting device becomes inoperative, the fail-safe solenoid switch valve is opened, and the disk brake system is actuated by brake fluid pressure generated by the master cylinder.

When an abnormality occurs in the brake-by-wire type brake system, it is desirable to generate a braking force that is larger than that generated during normal operation, thus reliably avoiding an emergency situation. However, in the above-mentioned conventional arrangement, the same disk brake system is operated both in the case of an abnormality and during normal operation, so that the braking force generated in the case of an abnormality is not always sufficient.

### SUMMARY

The present invention has been accomplished under the above-mentioned circumstances. It is an object thereof to provide a brake-by-wire type brake system that can generate a braking force that is larger than that generated during normal operation using brake fluid pressure generated by a driver's braking operation in the case of an abnormality in which electric braking means becomes inoperative.

In order to achieve the above-mentioned object, according to a first feature of the present invention, a brake system is provided. The brake system includes a master cylinder that generates brake fluid pressure by a driver's braking operation, a wheel cylinder that is provided on at least one wheel and can brake the wheel, and an electric braking means that can electrically brake at least one wheel. The brake system also includes a fluid passage that provides a connection between the master cylinder and the wheel cylinder, and a cut-off valve that is provided in the fluid passage. The cut-off valve closes during normal operation and opens when there is a malfunction in the electric braking means, wherein the wheel cylinder operates a drum brake system.

With the arrangement of the first feature, during normal operation in which the electric braking means is operative, when the cut-off valve is closed and communication between the master cylinder and the wheel cylinder is cut off, the wheel can be braked by the electric braking means. When there is an abnormality in which there is a malfunction in the electric braking means, when the cut-off valve is opened and the master cylinder and the wheel cylinder communicate with each other, the wheel can be braked by supplying the brake fluid pressure generated by the master cylinder to the wheel cylinder. In this process, since the brake fluid pressure actuates the wheel cylinder of the drum brake system having a high braking function, the braking force generated in the case of an abnormality can be made higher than the braking force during normal operation, thereby reliably stopping the vehicle.

According to a second feature of the present invention, in addition to the first feature, the electric braking device generates a braking force by pushing a brake pad against a brake disk, the brake pad being operated by an electric motor.

With the arrangement of the second feature, since the braking force is generated by the electric braking device pushing the brake pad against a brake disk, and since the brake pad is actuated by the electric motor, it is unnecessary to employ means for generating a brake fluid pressure, thus simplifying the structure.

According to a third feature of the present invention, in addition to the first feature, the electric braking device generates a brake fluid pressure that pushes a brake pad against a brake disk.

With the arrangement of the third feature, since the braking force is generated by pushing the brake pad against the brake disk using the brake fluid pressure generated by the electric braking device, it is possible to utilize an existing fluid-pressure-type disk brake system as it is, thus reducing the cost.

A second wheel cylinder 17 of embodiments corresponds to the wheel cylinder of the present invention, and a depressing force cut-off valve 19 of the embodiments corresponds to the cut-off valve of the present invention.

The above-mentioned object, other objects, characteristics, and advantages of the present invention will become apparent from an explanation of preferred embodiments that will be described in detail below by reference to the attached drawings.

### BRIEF DESCRIPTION OF THE DRAWINGS

FIG. 1 is a fluid pressure schematic diagram of a vehicular brake system of a first embodiment during normal operation.

FIG. 2 is the fluid pressure schematic diagram FIG. 1 corresponding to a case in which an abnormality occurs.

FIG. 3 is a fluid pressure schematic diagram of a vehicular brake system of a second embodiment during normal operation.

FIG. 4 is the fluid pressure schematic diagram FIG. 3 corresponding to a case in which an abnormality occurs.

FIG. 5 is a fluid pressure schematic diagram of a vehicular brake system of a third embodiment during normal operation.

FIG. 6 is the fluid pressure schematic diagram FIG. 5 corresponding to a case in which an abnormality occurs.

FIG. 7 is a fluid pressure schematic diagram of a vehicular brake system of a fourth embodiment during normal operation.

FIG. 8 is the fluid pressure schematic diagram FIG. 7 corresponding to a case in which an abnormality occurs.

FIG. 9 is a fluid pressure schematic diagram of a vehicular brake system of a fifth embodiment during normal operation.

FIG. 10 is the fluid pressure schematic diagram FIG. 9 corresponding to a case in which an abnormality occurs.

### DETAILED DESCRIPTION OF THE INVENTION

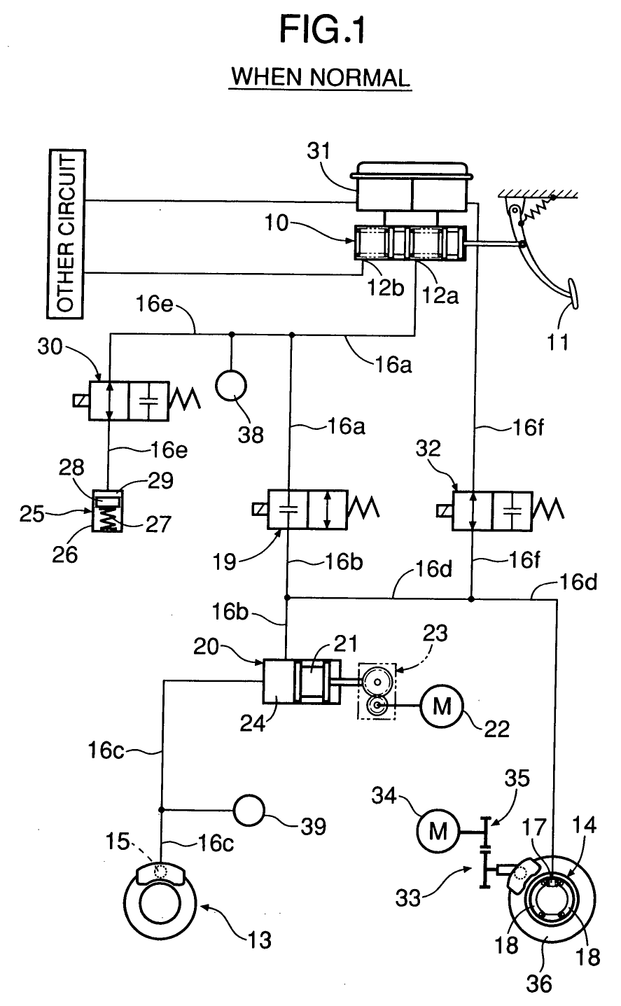

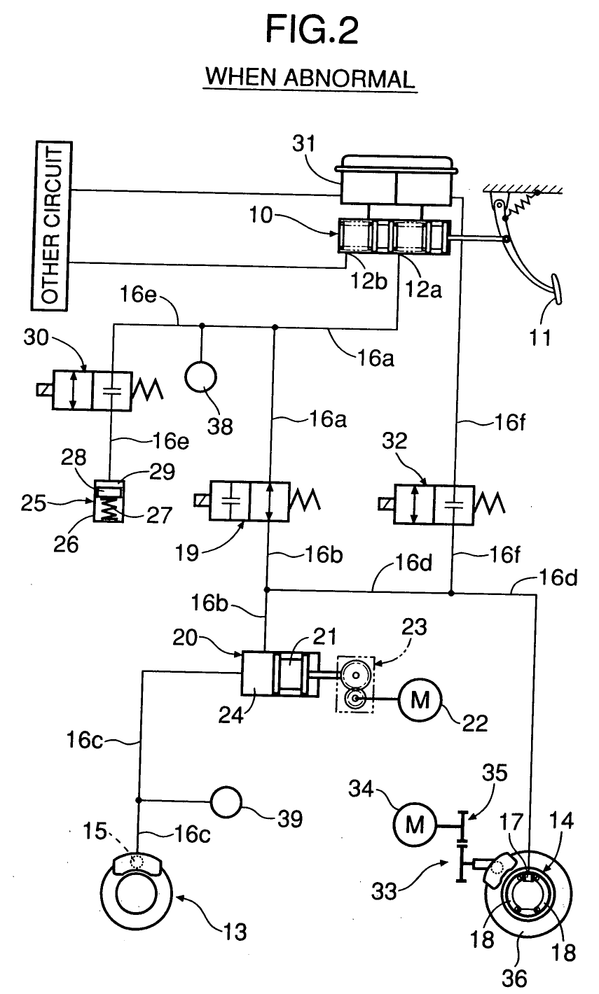

FIG. 1 and FIG. 2 show a first embodiment of the present invention. As shown in FIG. 1, a tandem master cylinder 10 includes first and second output ports 12a and 12b for outputting a brake fluid pressure corresponding to a depressing force with which a driver depresses a brake pedal 11. The first output port 12a is connected to, for example, a disk brake system 13 of a front left wheel and a drum brake system 14 of a rear right wheel. The second output port 12b is connected to, for example, a disk brake system of a front right wheel and a drum brake system of a rear left wheel. FIG. 1 shows only one brake circuit connected to the first output port 12a, and the other brake circuit connected to the second output port 12b is not illustrated, but the structures of both brake circuits are substantially the same. The brake circuit connected to the first output port 12a is explained below.

The first output port 12a of the master cylinder 10 and a first wheel cylinder 15 of the disk brake system 13 of the front wheel are connected via fluid passages 16a, 16b and 16c. A fluid passage 16d branching from the fluid passage 16b is connected to a second wheel cylinder 17 of the drum brake system 14 of the rear wheel. The drum brake system 14 brakes the rear wheel by device of a pair of brake shoes 18 that are operated by the second wheel cylinder 17.

Disposed between the fluid passage 16a and the fluid passage 16b is a depressing force cut-off valve 19 which is a normally open type solenoid valve. A motor cylinder 20 is disposed between the fluid passage 16b and the fluid passage 16c. A piston 21 is slidably fitted in the motor cylinder 20, and driven by an electric motor 22 via a speed reduction mechanism 23 to generate a brake fluid pressure in a fluid chamber 24 formed on a front face of the piston 21.

A stroke simulator 25 is connected to the downstream end of a fluid passage 16e that branches from a middle section of the fluid passage 16a. The stroke simulator 25 has a piston 28 slidably fitted in a cylinder 26, the piston 28 being biased by a spring 27. A fluid chamber 29 is formed on the side of the piston 28 opposite to the spring 27, and communicates with the fluid passage 16e. A simulator cut-off valve 30, which is a normally closed solenoid valve, is disposed in a middle section of the fluid passage 16e. A fluid passage 16f branches from a middle section of the fluid passage 16d, and communicates with a reservoir 31 of the master cylinder 10. An atmosphere cut-off valve 32, which is a normally closed solenoid valve, is disposed in a middle section of the fluid passage 16f.

The rear wheel is provided with an electric braking device 33 in addition to the drum brake system 14. The electric braking device 33 transmits the driving force of an electric motor 34 directly to brake pads via a reduction mechanism 35 (that is, not employing brake fluid pressure), and the brake pads sandwich a brake disk 36 to brake the rear wheel.

A fluid pressure sensor 38 for detecting a fluid pressure of the fluid passage 16e (or the fluid passage 16a) and a fluid pressure sensor 39 for detecting a fluid pressure of the fluid passage 16c are connected to an electronic control unit (not illustrated). The electronic control unit controls the operation of the depressing force cut-off valve 19, the simulator cut-off valve 30, the atmosphere cut-off valve 32, the electric motor 22 of the motor cylinder 20, and the electric motor 34 of the electric braking device 33.

The operation of the first embodiment of the present invention having the above-mentioned arrangement is now explained with reference to FIGS. 1 and 2.

During normal operation (FIG. 1), the solenoids of the depressing force cut-off valve 19, the simulator cut-off valve 30 and the atmosphere cut-off valve 32 are energized by commands from the electronic control unit. As a result, the depressing force cut-off valve 19 closes so as to cut off communication between the master cylinder 10 and the disk brake system 13, the simulator cut-off valve 30 opens so as to provide communication between the master cylinder 10 and the stroke simulator 25, and the atmosphere cut-off valve 32 opens. In this state, when the driver depresses the brake pedal 11 so as to make the master cylinder 10 generate a brake fluid pressure, the fluid pressure sensor 38 detects a fluid pressure of the fluid passage 16a (or the fluid passage 16e) which is blocked by the depressing force cut-off valve 19. The electronic control unit operates the electric motor 22 so as to generate the same fluid pressure in the fluid passage 16c as the fluid pressure detected by the fluid pressure sensor 38.

As a result, the driving force of the electric motor 22 is transmitted to the piston 21 via the reduction mechanism 23, and a brake fluid pressure generated in the fluid chamber 24 of the motor cylinder 20 is transmitted to the first wheel cylinder 15 of the disk brake system 13 via the fluid passage 16c, thereby braking the front wheel. In this process, the fluid pressure of the fluid passage 16c is detected by the fluid pressure sensor 39, and the electronic control unit feedback-controls the operation of the electric motor 22 so that this fluid pressure coincides with the fluid pressure detected by the fluid pressure sensor 38 of the fluid passage 16e.

When the piston 21 of the motor cylinder 20 is moved slightly forward by the electric motor 22, communication between the fluid chamber 24 and the fluid passage 16b is cut off. Therefore, there is no possibility of the brake fluid pressure generated by the motor cylinder 20 escaping to the reservoir 31 via the atmosphere cut-off valve 32 provided in the fluid passage 16f.

During the above-mentioned normal operation, since the depressing force cut-off valve 19 is held in a closed state unless an abnormal state such as breakdown of a power source occurs, there are conventional problems that occur. In particular, if the brake pads of the disk brake system 13 are worn and the volume of the fluid passage 16c between the motor cylinder 20 and the disk brake system 13 increases, an amount of brake fluid corresponding to the increase cannot be replenished from the reservoir 31, and moreover drag of the first wheel cylinder 15 cannot be reduced.

However, in this embodiment, when the piston 21 of the motor cylinder 20 retreats, the fluid chamber 24 communicates with the reservoir 31 via the opened atmosphere cut-off valve 32, any shortfall in the brake fluid that due to the worn brake pads of the disk brake system 13 can be replenished from the reservoir 31, and drag of the first wheel cylinder 15 when the braking force is released can be reduced.

Furthermore, during normal operation in which the driver depresses the brake pedal 11 and the master cylinder 10 generates a brake fluid pressure, the brake fluid pressure is transmitted to the fluid chamber 29 of the stroke simulator 25. As a consequence, the piston 28 moves against the elastic force of the spring 27, thereby generating a reaction force against the depression of the brake pedal 11. This can provide an operational feeling similar to that given when the disk brake system 13 is operated by a driver's depressing force, although the disk brake system 13 is actually operated by the driving force of the electric motor 22.

As described above, while the disk brake system 13 brakes the front wheel, the electric motor 34 of the electric braking system 33 is operated by a command from the electronic control unit, the driving force of the electric motor 34 is transmitted to the brake pads via the reduction mechanism 35, and the brake pads sandwich the brake disk 36 so as to brake the rear wheel. As a result, the front wheel is braked by brake fluid pressure generated by the driving force of the electric motor 22, and the rear wheel is braked directly by the driving force of the electric motor 34.

When there is an abnormality in brake operation such as breakdown of the power source caused by detachment of a battery, etc., the depressing force cut-off valve 19 opens so as to provide communication between the master cylinder 10 and the disk brake system 13; the simulator cut-off valve 30 closes so as to cut off communication between the master cylinder 10 and the stroke simulator 25; and the atmosphere cut-off valve 32 closes so as to cut off communication between the master cylinder 10 and the reservoir 31, as shown in FIG. 2. As a result, the brake fluid pressure generated by the master cylinder 10 operated by the driver depressing the brake pedal 11 is transmitted to the first wheel cylinder 15 of the disk brake system 13 via the fluid passage 16a, the opened depressing force cut-off valve 19, the fluid passage 16b, and the fluid passage 16c, thus braking the front wheel.

Concurrently, the brake fluid pressure generated by the master cylinder 10 is transmitted to the second wheel cylinder 17 of the drum brake system 14 via the fluid passage 16a, the opened depressing force cut-off valve 19, the fluid passage 16b and the fluid passage 16d, thus braking the rear wheel. Furthermore, since communication between the stroke simulator 25 and the master cylinder 10 is cut off by the simulator cut-off valve 30 being closed, the stroke simulator 25 stops functioning. As a result, it is possible to prevent the driver from having an uncomfortable sensation due to the stroke of the brake pedal 11 unnecessarily increasing. Moreover, the brake fluid pressure generated by the master cylinder 10 is transmitted to the first and second wheel cylinders 15 and 17 at the front and rear without being absorbed by the stroke simulator 25, thus generating a braking force with high responsiveness.

Even if the electric power source breaks down and the depressing force cut-off valve 19, the simulator cut-off valve 30, the atmosphere cut-off valve 32, and the electric motors 22 and 34 become inoperative, the first and second wheel cylinders 15 and 17 of the front wheel and the rear wheel can be operated without any problem by device of the brake fluid pressure generated by the master cylinder 10 operated by the driver depressing the brake pedal 11, so that not only the front wheel but also the rear wheel can be braked in case of abnormality, thereby more safely stopping the vehicle.

In general, a disk brake system has the characteristics that its heat dissipating properties are good and its performance is difficult to be degraded in continuous operation. A drum brake system has the characteristics that it has a self-servo function and the braking function is high, but its heat dissipating properties are poor. Therefore, as a brake system for use during normal operation, the disk brake system is considered to be superior, and in order to generate a large braking force temporarily in case of emergency, the drum brake system is considered to be superior.

In this embodiment, since the rear wheel, which has a high braking function in the case of an abnormality, is braked by the drum brake system 14, the vehicle can be more safely stopped as compared with a case where the rear wheel is braked by the disk brake system 13.

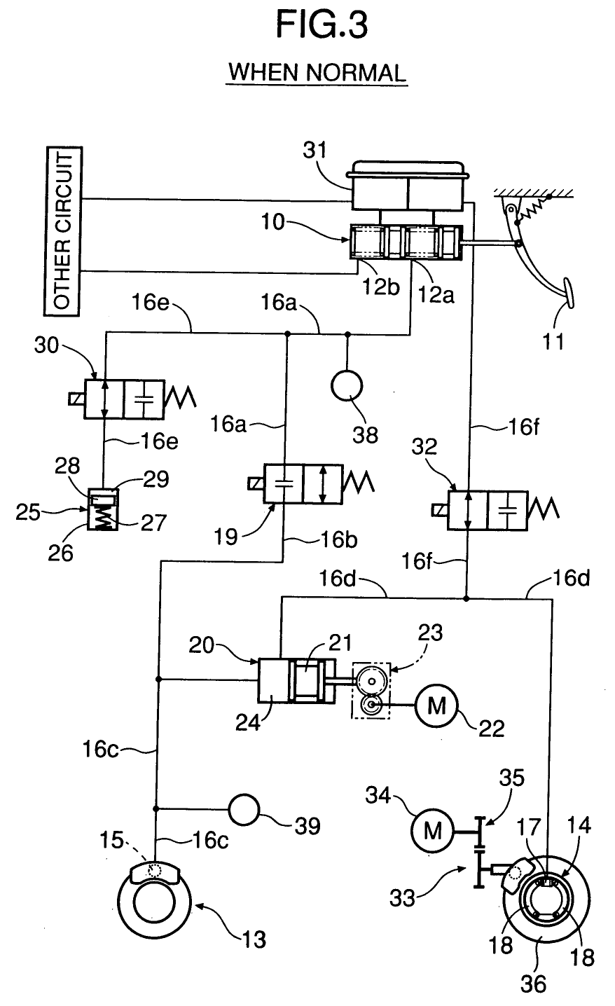

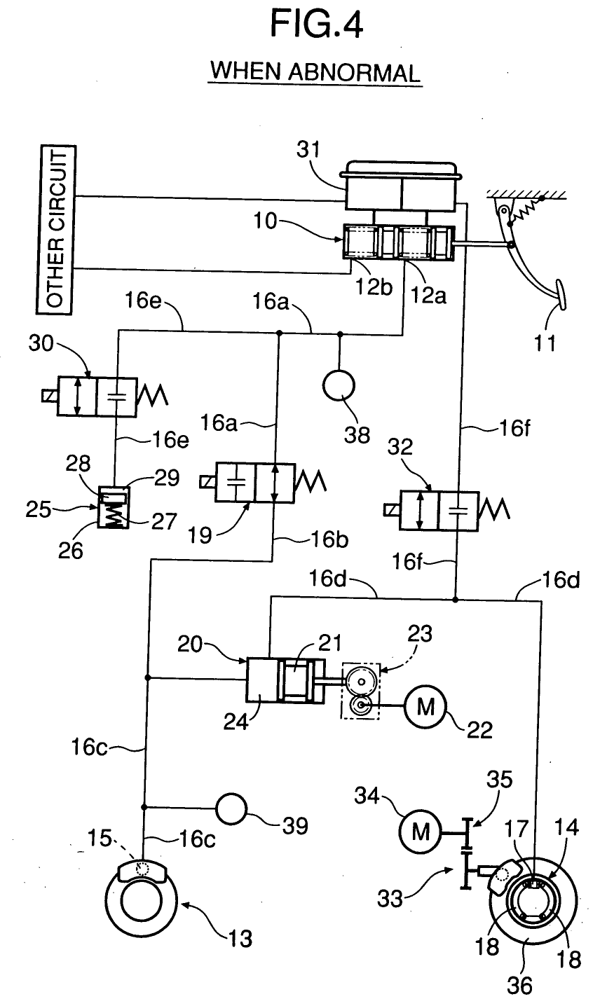

A second embodiment of the present invention is now explained by reference to FIG. 3 and FIG. 4. In the second embodiment and embodiments thereafter, components corresponding to the components of the first embodiment are denoted by the same reference numerals and symbols, and duplication of the explanation is omitted.

The second embodiment is a modification of the first embodiment. Whereas in the first embodiment the fluid chamber 24 of the motor cylinder 20 is disposed between the fluid passages 16b and 16c that provide a connection between the master cylinder 10 and the disk brake system 13 of the front wheel, in the second embodiment fluid passages 16b and 16c communicate directly with each other, and these fluid passages 16b and 16c communicate with an output port of a fluid chamber 24 of a motor cylinder 20. Therefore, in the case of an abnormality shown in FIG. 4, when a disk brake system 13 of a front wheel is operated by brake fluid pressure generated by a master cylinder 10, in the first embodiment the brake fluid pressure is transmitted via the fluid chamber 24 of the motor cylinder 20, but in the second embodiment it is transmitted without passing through the fluid chamber 24 of the motor cylinder 20.

Also in the second embodiment, in the case of an abnormality in brake operation, not only the front wheel but also a rear wheel are braked by the brake fluid pressure generated by the master cylinder 10, thus reliably stopping the vehicle, and moreover, since a drum brake system 14 having a high braking function is employed for the rear wheel, the vehicle can be more reliably stopped.

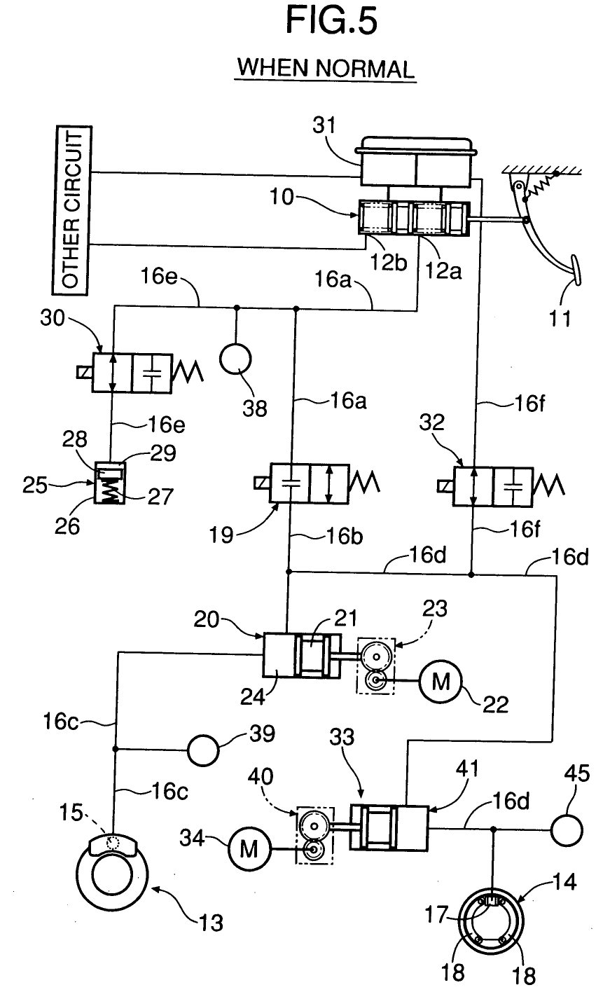

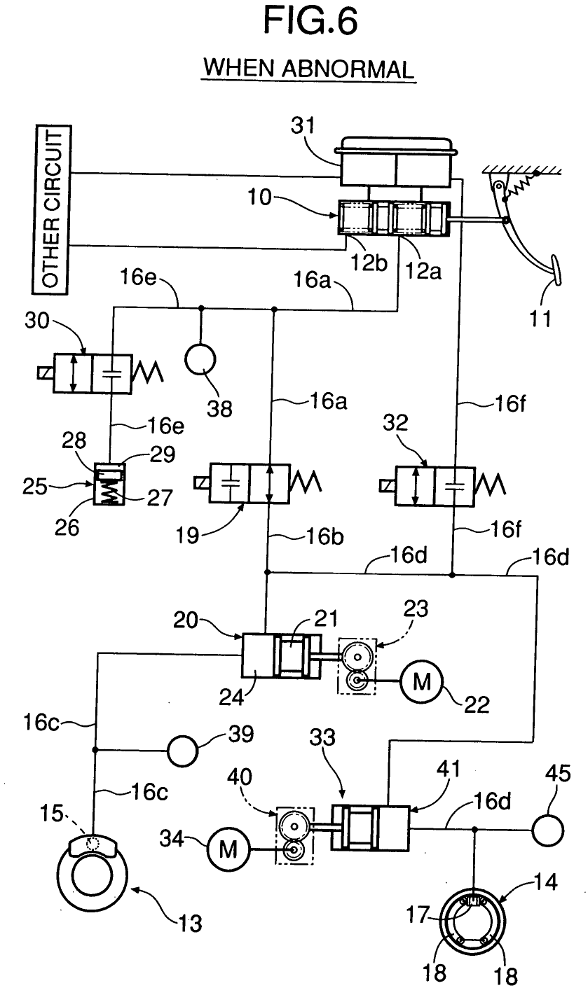

A third embodiment of the present invention is now explained by reference to FIG. 5 and FIG. 6.

The third embodiment is a modification of the first embodiment. Whereas in the first embodiment the electric braking device 33 of the rear wheel directly brakes the brake disk 36 by device of the driving force of the electric motor 34, in the third embodiment the second wheel cylinder 17 for driving brake shoes 18 of a drum brake system 14 is operated by brake fluid pressure generated by a motor cylinder 41 driven by an electric motor 34 via a reduction mechanism 40.

The electric motor 34 for driving the motor cylinder 41 of a rear wheel is controlled so that a fluid pressure detected by a fluid pressure sensor 45 coincides with a fluid pressure detected by a fluid pressure sensor 38.

Also in the third embodiment, in the case of an abnormality in brake operation shown in FIG. 6, not only a front wheel but also the rear wheel are braked by brake fluid pressure generated by a master cylinder 10, thus reliably stopping the vehicle, and moreover, since the drum brake system 14 having a high braking function is employed for the rear wheel, the vehicle can be more reliably stopped.

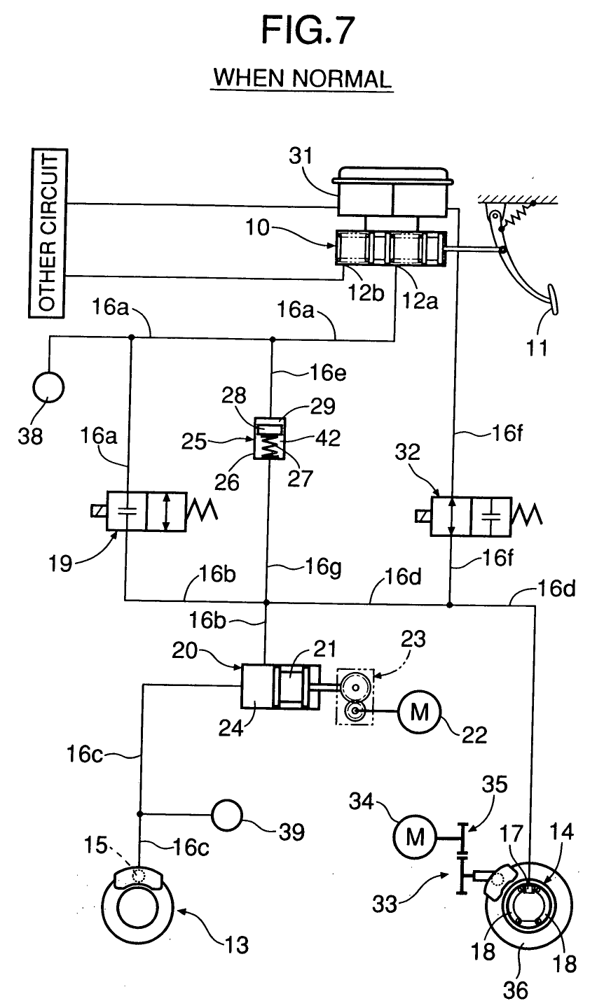

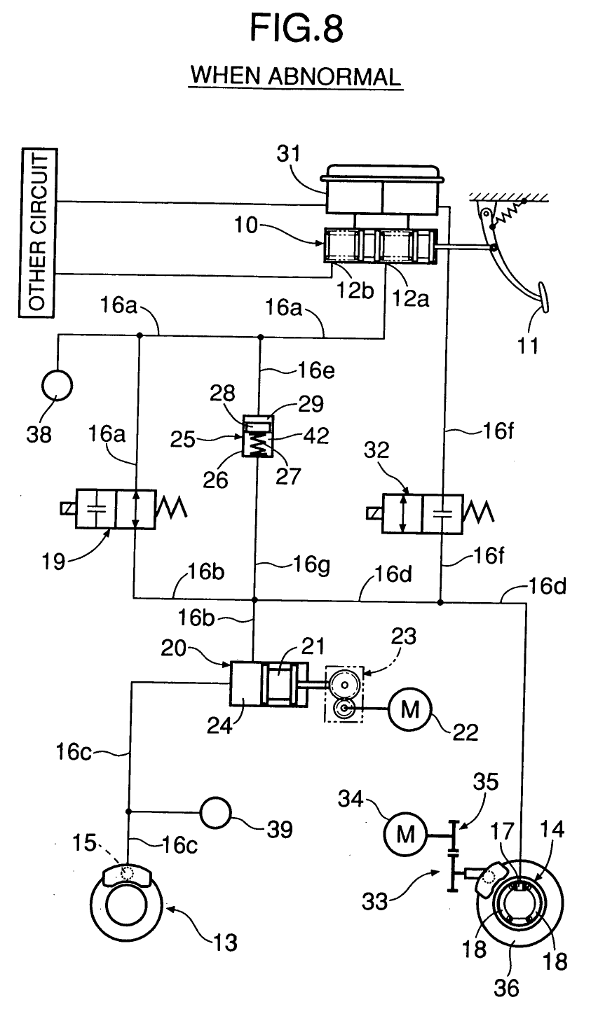

A fourth embodiment of the present invention is now explained by reference to FIG. 7 and FIG. 8.

The fourth embodiment is a modification of the first embodiment. In the fourth embodiment, a back chamber 42 housing a spring 27 of a stroke simulator 25 communicates via a fluid passage 16g with a branch section between fluid passages 16b and 16d.

Therefore, during normal operation shown in FIG. 7, a disk brake system 13 of a front wheel is operated by brake fluid pressure generated by a motor cylinder 20 operated by an electric motor 22, and electric braking device 33 of a rear wheel is directly operated by a driving force generated by an electric motor 34, so that the vehicle can be braked. In this process, an atmosphere cut-off valve 32 opens so as to provide communication between a reservoir 31 and the back chamber 42 of the stroke simulator 25, brake fluid pressure transferred from a master cylinder 10 to a fluid chamber 29 moves a piston 28 against the resilient force of the spring 27, and brake fluid of the back chamber 42 escapes to the reservoir 31 via the atmosphere cut-off valve 32, thus enabling the stroke simulator 25 to exert its function.

When there is an abnormality in braking operation, as shown in FIG. 8, a depressing force cut-off valve 19 is opened, and the brake fluid pressure generated by the master cylinder 10 operates a disk brake system 13 of a front wheel and a drum brake system 14 of a rear wheel. In this process, since the brake fluid pressure from the master cylinder 10 is applied to both the fluid chamber 29 and the back chamber 42 of the stroke simulator 25, the piston 28 becomes immobile, and the stroke simulator 25 stops functioning. Therefore, it is possible to prevent the stroke of the brake pedal 11 from unnecessarily increasing, thereby preventing the braking feeling from being degraded.

Also in the fourth embodiment, in the case of an abnormality as shown in FIG. 8, not only the front wheel but also the rear wheel are braked by the brake fluid pressure generated by the master cylinder 10, thus reliably stopping the vehicle, and moreover, since the drum brake system 14 having a high braking function is employed for the rear wheel, the vehicle can be more reliably stopped.

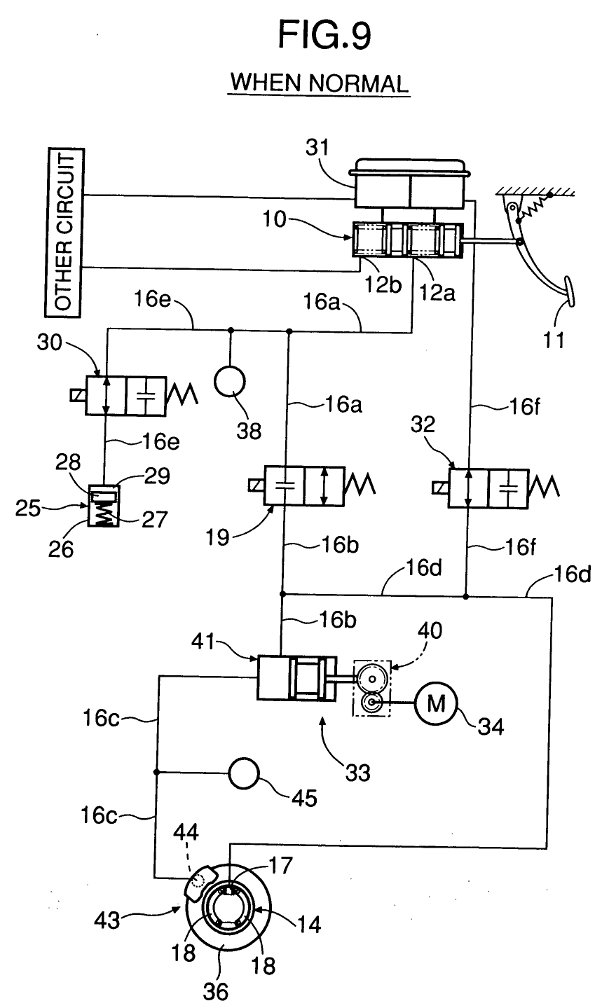

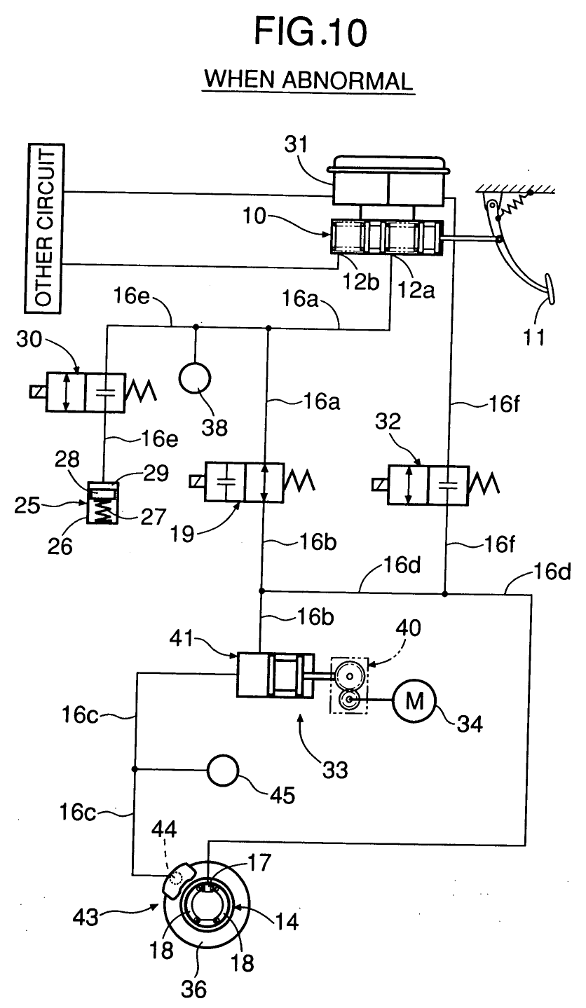

A fifth embodiment of the present invention is now explained by reference to FIG. 9 and FIG. 10.

In the above-mentioned first through fourth embodiments, both the front wheel and the rear wheel are braked by a single system, but in the fifth embodiment either one of the front wheel or the rear wheel is braked by a single system.

A wheel is provided with a drum brake system 14 and a disk brake system 43. An electric braking system 33 having the same structure as in the third embodiment, that is, the structure that generates a brake fluid pressure by operating a motor cylinder 41 by an electric motor 34, is connected to a wheel cylinder 44 of the disk brake system 43. Furthermore, a fluid passage 16d, branching from a fluid passage 16b provided between a depressing force cut-off valve 19 and the motor cylinder 41, is connected to a second wheel cylinder 17 of the drum brake system 14. An atmosphere cut-off valve 32 is disposed in a fluid passage 16f branching from the fluid passage 16d to communicate with a reservoir 31.

Therefore, during normal operation shown in FIG. 9, the disk brake system 43 of the wheel can be operated, with the depressing force cut-off valve 19 closed, by means of brake fluid pressure generated by the motor cylinder 41 operated by the electric motor 34. Furthermore, in the case of an abnormal operation of the brake system, shown in FIG. 10, the drum brake system 14 of the wheel can be operated by brake fluid pressure generated by the master cylinder 10 by opening the depressing force cut-off valve 19.

Also in the fifth embodiment, in the case of an abnormality shown in FIG. 10, it is possible to more reliably stop the vehicle by operating the drum brake system 14 which has a high braking function.

Although embodiments of the present invention have been described above, the present invention is not limited thereto, and can be modified in a variety of ways without departing from the subject matter of the present invention.

What is claimed is:

1. A brake system comprising:
a master cylinder that generates brake fluid pressure by a driver's braking operation;
a wheel cylinder that is provided on at least one wheel and can brake the wheel;
an electric braking device that can electrically brake said at least one wheel;
a fluid passage that provides a connection between the master cylinder and the wheel cylinder; and
a cut-off valve that is provided in the fluid passage, the cut-off valve configured to close during normal operation, and open when there is a malfunction in the electric braking device,
wherein the wheel cylinder operates a drum brake system.

2. The brake system according to claim 1, wherein the electric braking device generates a braking force by pushing a brake pad against a brake disk, the brake pad being actuated by an electric motor.

3. The brake system according to claim 1, wherein the electric braking device generates a brake fluid pressure that pushes a brake pad against a brake disk.

4. A brake system comprising:
a master cylinder that generates brake fluid pressure by a driver's braking operation;
a wheel cylinder that is provided on at least one wheel and can brake the wheel;
an electric braking device that can electrically brake said at least one wheel;
a fluid passage that provides a connection between the master cylinder and the wheel cylinder; and
a cut-off valve that is provided in the fluid passage, the cut-off valve configured to close during normal operation, and open when there is a malfunction in the electric braking device,
a disk brake actuated by fluid pressure generated by said electric braking device, the disk brake operably connected to said at least one wheel, and
a drum brake actuated by fluid pressure generated by said master cylinder, the drum brake operably connected to said at least one wheel,
wherein during normal operation of the brake system, the cut-off valve is closed and the at least one wheel is braked by means of the disk brake, and
during abnormal operation of the brake system, the cut-off valve is open and the at least one wheel is braked by means of the drum brake.

5. The brake system according to claim 4, wherein the electric braking device generates a braking force by pushing a brake pad against a brake disk, the brake pad being actuated by an electric motor.

6. The brake system of claim 4, further comprising a fluid pressure sensor disposed between the master cylinder and the cut-off valve,
wherein during normal operation of the brake system, the at least one wheel is braked by means of the disk brake at a pressure substantially the same as that sensed by the fluid pressure sensor.
